(19) United States
(12) Patent Application Publication
(10) Pub. No.: US 2012/0042784 A1
(43) Pub. Date: Feb. 23, 2012

(54) AERATION APPARATUS INCLUDING WATER-REPELLENT LAYER AND SEAWATER FLUE GAS DESULFURIZATION APPARATUS INCLUDING THE SAME

(76) Inventors: Keisuke SONODA, Tokyo (JP); Shozo Nagao, Tokyo (JP); Koji Imasaka, Tokyo (JP); Seiji Furukawa, Tokyo (JP); Yoshihiko Tsuchiyama, Tokyo (JP)

(21) Appl. No.: 13/207,509

(22) Filed: Aug. 11, 2011

Related U.S. Application Data
(60) Provisional application No. 61/436,752, filed on Jan. 27, 2011.

(30) Foreign Application Priority Data
Aug. 18, 2010 (JP) 2010-183500

(51) Int. Cl. B01F 3/04; C02F 1/74; C02F 7/00; B01D 47/00

(52) U.S. Cl. 96/235; 261/121.1

(57) ABSTRACT

In an aeration apparatus according to the present invention, water-repellent treatment is applied at least to one of an opening and vicinity thereof of a slit 12 formed in a diffuser membrane of an aeration nozzle, thereby providing a water-repellent layer 150, so that the inflow of seawater into the slit 12 is prevented and precipitation of calcium sulfate or the like in the slit is suppressed and avoided. As a material for forming the water-repellent layer 150, for example, a talc coating layer using talc, a fluorine coating layer coated with a fluorine resin, silicone coating layer coated with a silicone resin, and a wax coating layer coated with wax can be mentioned.

### FIELD

The present invention relates to wastewater treatment in a flue gas desulphurization apparatus used in a power plant such as a coal, crude oil, or heavy oil combustion power plant. In particular, the invention relates to an aeration apparatus for aeration used for decarboxylation (air-exposure) of wastewater (used seawater) from a flue gas desulphurization apparatus for desulphurization using a seawater method. The invention also relates to a seawater flue gas desulphurization apparatus including the aeration apparatus.

### BACKGROUND

In conventional power plants that use coal, crude oil, and the like as fuel, combustion flue gas (hereinafter referred to as “gas”) discharged from a boiler is emitted to the air after sulfur oxides (SOₓ) such as sulfur dioxide (SO₂) contained in the flue gas are removed. Known examples of the desulphurization method used in a flue gas desulphurization apparatus for the above desulphurization treatment include a limestone-gypsum method, spray dryer method, and seawater method.

In a flue gas desulphurization apparatus that uses the seawater method (hereinafter referred to as a “seawater flue gas desulphurization apparatus”), its desulphurization method uses seawater as an absorbent. In this method, seawater and flue gas from a boiler are supplied to the inside of a desulfurizer (absorber) having a vertical tubular shape such as a vertical substantially cylindrical shape, and the flue gas is brought into gas-liquid contact with the seawater used as the absorbent in a wet process to remove sulfur oxides. The seawater (used seawater) used as the absorbent for desulphurization in the desulfurizer flows through, for example, a long water passage having an open upper section (Seawater Oxidation Treatment System: SOTS) and is then discharged. In the long water passage, the seawater is decarbonated (exposed to air) by aeration that uses fine air bubbles ejected from an aeration apparatus disposed on the bottom surface of the water passage (Patent documents 1 to 3).

### Citation List

### Patent Literature

Patent Literature 1: Japanese Patent Application Laid-open No. 2006-055779

Patent Literature 2: Japanese Patent Application Laid-open No. 2009-028570

Patent Literature 3: Japanese Patent Application Laid-open No. 2009-028572

### SUMMARY

### Technical Problem

Aeration nozzles used in the aeration apparatus each have a large number of small slits formed in a rubber-made diffuser membrane that covers a base. Such aeration nozzles are generally referred to as “diffuser nozzles.” These aeration nozzles can eject many fine air bubbles of substantially equal size from the slits with the aid of the pressure of the air supplied to the nozzles. Conventionally, in the case of a rubber-made diffuser membrane, the length of the slit is about 1 to 3 millimeters.

When aeration is continuously performed in seawater using the above aeration nozzles, precipitates such as calcium sulfate in the seawater are deposited on the wall surfaces of the slits of the diffuser membranes and around the openings of the slits, causing the gaps of the slits to be narrowed and the slits to be clogged. This results an increase in pressure loss of the diffuser membranes, and the discharge pressure of discharge unit, such as a blower or compressor, for supplying the air to the diffuser is thereby increased, so that disadvantageously the load on the blower or compressor increases.

The occurrence of the precipitates may be due to the following reason. Seawater present outside a diffuser membrane permeates inside the diffuser membrane through its slits and comes into continuous contact with air passing through the slits for a long time. Drying (concentration of the seawater) is thereby facilitated, and the precipitates are deposited.

In view of the above problem, it is an object of the present invention to provide an aeration apparatus that can suppress and avoid generation of precipitates in the slits of diffuser membranes, and a seawater flue gas desulfurization apparatus including the aeration apparatus.

### Solution to Problem

According to an aspect of the present invention, an aeration apparatus that is immersed in water to be treated and generates fine air bubbles in the water to be treated, includes: an air supply pipe for supplying air through a discharge unit; and an aeration nozzle including a diffuser membrane having a slit, the air being supplied through the slit to the aeration nozzle. A water-repellent layer is provided at least at one of an opening and vicinity thereof of the slit.

Advantageously, in the aeration apparatus, the water-repellent layer is a coating layer made of a hydrophobic material.

Advantageously, in the aeration apparatus, the water-repellent layer is any one of a fluorine coating layer, a silicone coating layer, and a wax coating layer.

Advantageously, in the aeration apparatus, the water-repellent layer is a fractal structure layer.

Advantageously, in the aeration apparatus, the diffuser membrane is made of rubber, metal, or ceramic.

According to another aspect of the present invention, an aeration apparatus that is immersed in water to be treated and generates fine air bubbles in the water to be treated, includes: an air supply pipe for supplying air through a discharge unit; and an aeration nozzle including a diffuser membrane having a slit, the air being supplied through the slit to the aeration nozzle. The diffuser membrane is formed by adding a hydrophobic material thereto in an amount from 25 to 95 parts by weight per 100 parts by weight of a rubber material, and a water-repellent layer is provided at least at one of an opening and vicinity thereof of the slit.

According to still another aspect of the present invention, an aeration apparatus that is immersed in water to be treated and generates fine air bubbles in the water to be treated, includes: an air supply pipe for supplying air through a discharge unit; an aeration nozzle including a diffuser membrane having a slit, the air being supplied through the slit to the aeration nozzle; and a hydrophobic-material supply unit that adds a hydrophobic material to the air supply pipe.

According to still another aspect of the present invention, a seawater flue gas desulphurization apparatus includes: a desulfurizer that uses seawater as an absorbent; a water passage for discharging used seawater discharged from the desulfurizer; and the aeration apparatus according to any one of claims 1 to 7 that is disposed in the water passage, the aeration apparatus generating fine air bubbles in the used seawater to decarbonate the used seawater.

### Advantageous Effects of Invention

According to the present invention, generation of precipitates can be suppressed and avoided in the slits of the diffuser membranes of the aeration apparatus.

### BRIEF DESCRIPTION OF DRAWINGS

FIG. 1 is a schematic diagram of a seawater flue gas desulphurization apparatus according to an embodiment.

FIG. 2A is a plan view of aeration nozzles.

FIG. 2B is a front view of the aeration nozzles.

FIG. 3 is a schematic diagram of the inner structure of an aeration nozzle.

FIG. 4 is a schematic diagram of an aeration apparatus according to the embodiment.

FIG. 5 is a schematic diagram of an opening of a slit formed in a diffuser membrane of the aeration nozzle according to the embodiment.

FIG. 6A depicts the outflow of air (humid air having a low degree of saturation), the inflow of seawater, and a state of concentrated seawater in the slit of the diffuser membrane.

FIG. 6B depicts the outflow of air, the inflow of seawater, and states of concentrated seawater and precipitates in the slit of the diffuser membrane.

FIG. 6C depicts the outflow of air, the inflow of seawater, and states of concentrated seawater and precipitates (when precipitates grow) in the slit of the diffuser membrane.

FIG. 7 is a schematic diagram of another aeration apparatus according to the embodiment.

FIG. 8 is an example of a pattern diagram of a fractal structure.

FIG. 9 is a chart obtained by analyzing precipitates by X-ray diffraction.

### DESCRIPTION OF EMBODIMENTS

Hereinafter, the present invention will be described in detail with reference to the drawings. However, the present invention is not limited to embodiments described below. The components in the following embodiments include those readily apparent to persons skilled in the art and those substantially similar thereto.

### Embodiments

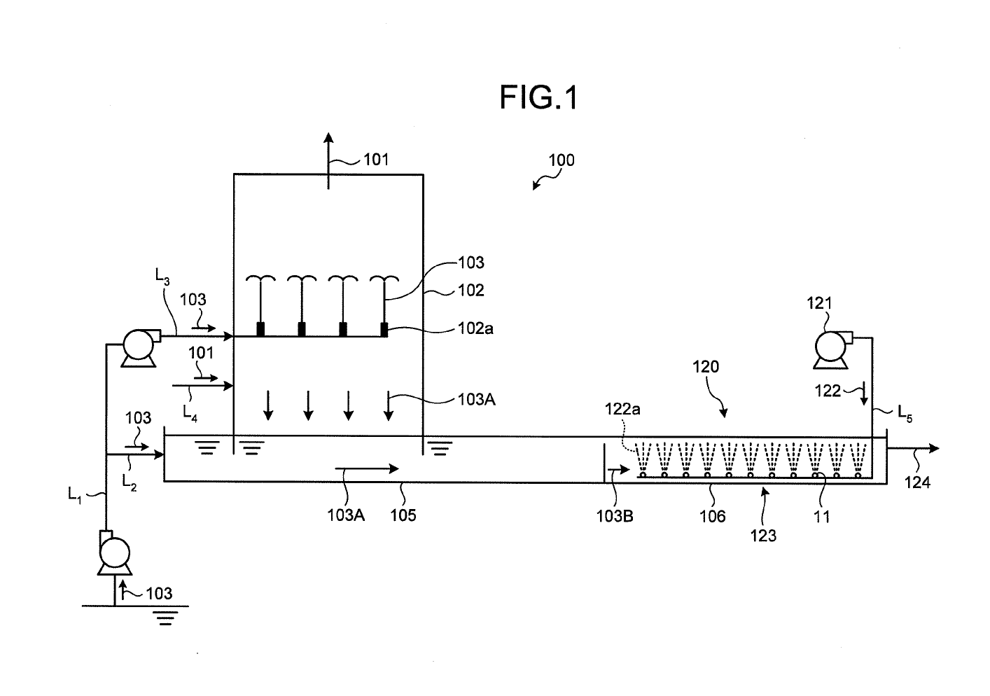

An aeration apparatus and a seawater flue gas desulphurization apparatus according to embodiments of the present invention will be described with reference to the drawings. FIG. 1 is a schematic diagram of the seawater flue gas desulphurization apparatus according to one embodiment.

As shown in FIG. 1, a seawater flue gas desulphurization apparatus 100 includes: a flue gas desulphurization absorber 102 in which flue gas 101 and seawater 103 comes in gas-liquid contact to desulphurize SO₂ into sulfurous acid (H₂SO₃); a dilution-mixing basin 105 disposed below the flue gas desulphurization absorber 102 to dilute and mix used seawater 103A containing sulfur compounds with dilution seawater 103; and an oxidation basin 106 disposed on the downstream side of the dilution-mixing basin 105 to subject diluted used seawater 103B to water quality recovery treatment.

In the seawater flue gas desulphurization apparatus 100, the seawater 103 is supplied through a seawater supply line L₁, and part of the seawater 103 is used for absorption, i.e., is brought into gas-liquid contact with the flue gas 101 in the flue gas desulphurization absorber 102 to absorb SO₂ contained in the flue gas 101 into the seawater 103. The used seawater 103A that has absorbed the sulfur components in the flue gas desulphurization absorber 102 is mixed with the dilution seawater 103 supplied to the dilution-mixing basin 105 disposed below the flue gas desulphurization absorber 102. The diluted used seawater 103B diluted and mixed with the dilution seawater 103 is supplied to the oxidation basin 106 disposed on the downstream side of the dilution-mixing basin 105. Air 122 supplied from an oxidation air blower 121 is supplied to the oxidation basin 106 from aeration nozzles 123 to recover the quality of the seawater, and the resultant water is discharged to the sea as treated water 124.

In FIG. 1, reference numeral 102a represents spray nozzles for injecting seawater upward as liquid columns; 120 represents an aeration apparatus; 122a represents air bubbles; L₁ represents a seawater supply line; L₂ represents a dilution seawater supply line; L₃ represents a desulphurization seawater supply line; L₄ represents a flue gas supply line; and L₅ represents an air supply line.

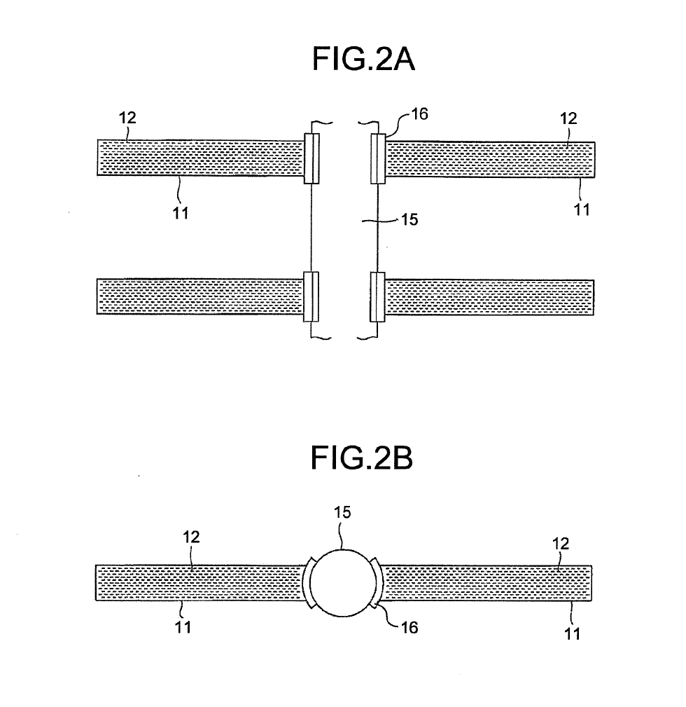

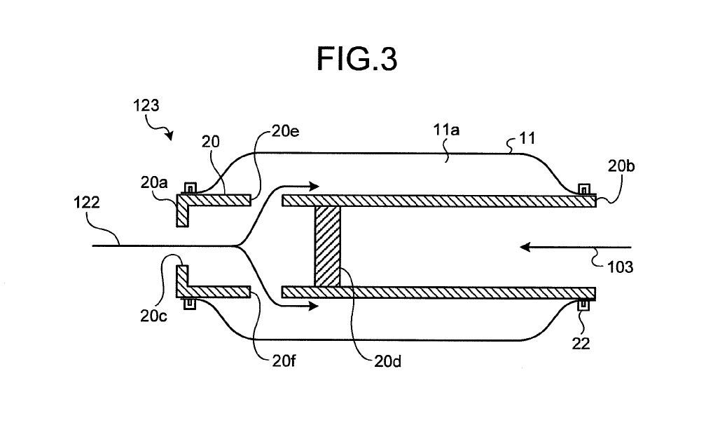

The structure of the aeration nozzles 123 is described with reference to FIGS. 2A, 2B, and 3.

FIG. 2A is a plan view of the aeration nozzles; FIG. 2B is a front view of the aeration nozzles; and FIG. 3 is a schematic diagram of the inner structure of an aeration nozzle.

As shown in FIGS. 2A and 2B, each aeration nozzle 123 has a large number of small slits 12 formed in a rubber-made diffuser membrane 11 that covers the circumference of a base and is generally referred to as a “diffuser nozzle.” In such an aeration nozzle 123, when the diffuser membrane 11 is expanded by the pressure of the air 122 supplied from the air supply line L₅, the slits 12 open to allow a large number of fine air bubbles of substantially equal size to be ejected.

As shown in FIGS. 2A and 2B, the aeration nozzles 123 are attached through flanges 16 to headers 15 provided in a plurality of (eight in the present embodiment) branch pipes (not shown) branched from the air supply line L₅. In consideration of corrosion resistance, resin-made pipes, for example, are used as the branch pipes and the headers 15 disposed in the diluted used seawater 103B.

For example, as shown in FIG. 3, each aeration nozzle 123 is formed as follows. A substantially cylindrical support body 20 that is made of a resin in consideration of corrosion resistance to the diluted used seawater 103B is used, and a rubber-made diffuser membrane 11 having a large number of slits 12 formed therein is fitted on the support body 20 so as to cover its outer circumference. Then the left and right ends of the diffuser membrane 11 are fastened with fastening members 22 such as wires or bands.

The slits 12 described above are closed in a normal state in which no pressure is applied thereto. In the seawater flue gas desulphurization apparatus 100, because the air 122 is continuously supplied, the slits 12 are constantly in an open state.

A first end 20a of the support body 20 is attached to a header 15 and allows the introduction of the air 122, and the support body 20 has an opening at its second end 20b that allows the introduction of the seawater 103.

In the support body 20, the side close to the first end 20a is in communication with the inside of the header 15 through an air inlet port 20c that passes through the header 15 and the flange 16. The inside of the support body 20 is partitioned by a partition plate 20d disposed at some axial position in the support body 20, and the flow of air is blocked by the partition plate 20d. Air outlet holes 20e and 20f are formed in the side surface of the support body 20 and disposed on the header 15 side of the partition plate 20d. The air outlet holes 20e and 20f allow the air 122 to flow between the inner circumferential surface of the diffuser membrane 11 and the outer circumferential surface of the support body, i.e., into a pressurization space 11a for pressurizing and expanding the diffuser membrane 11. Therefore, the air 122 flowing from the header 15 into the aeration nozzle 123 flows through the air inlet port 20c into the support body 20 and then flows through the air outlet holes 20e and 20f formed in the side surface into the pressurization space 11a, as shown by arrows in FIG. 3.

The fastening members 22 fasten the diffuser membrane 11 to the support body 20 and prevent the air flowing through the air outlet holes 20e and 20f from leaking from the opposite ends.

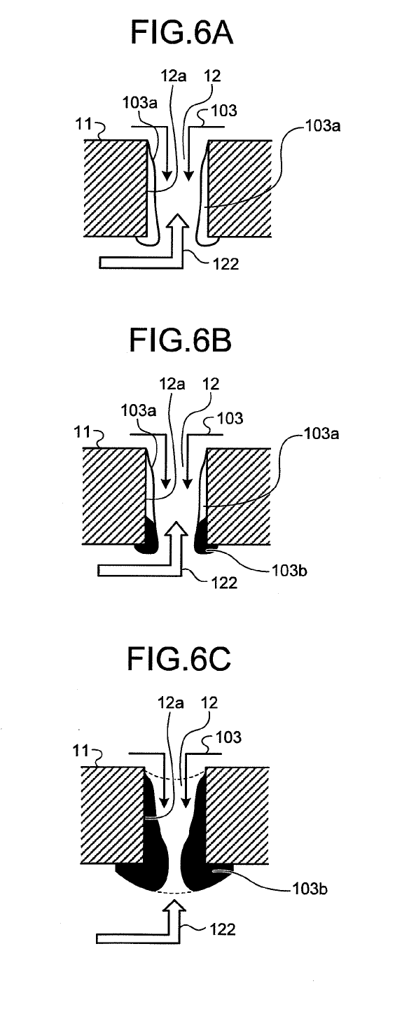

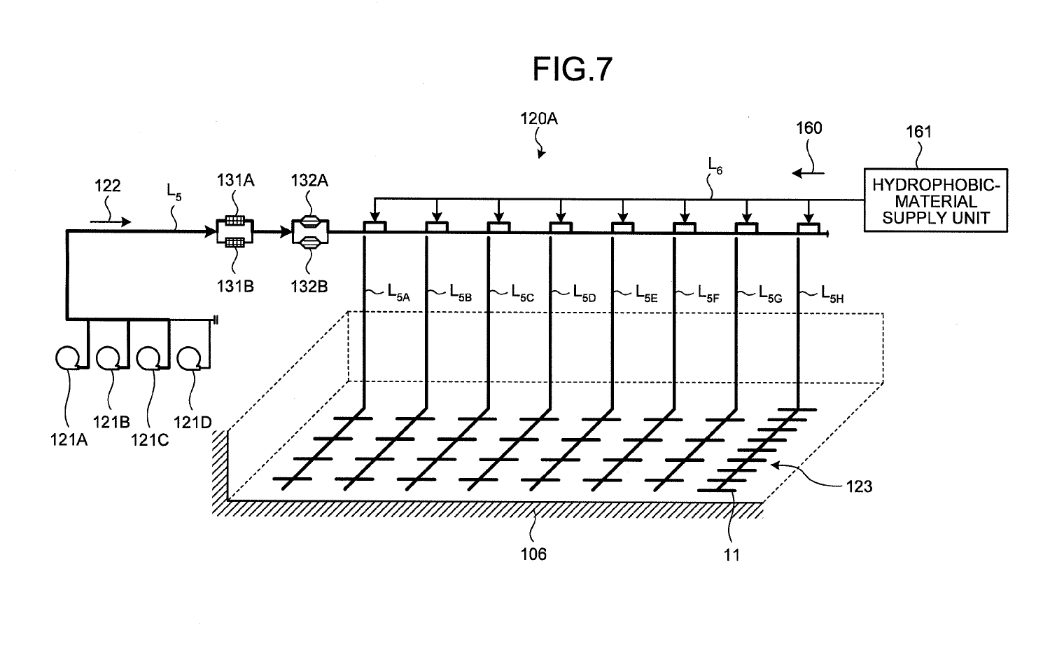

In the aeration nozzle 123 configured as above, the air 122 flowing from the header 15 through the air inlet port 20c flows through the air outlet holes 20e and 20f into the pressurization space 11a. Since the slits 12 are closed in the initial state, the air 122 is accumulated in the pressurization space 11a to increase the inner pressure. The increase in the inner pressure of the pressurization space 11a causes the diffuser membrane 11 to expand, and the slits 12 formed in the diffuser membrane 11 are thereby opened, so that fine bubbles of the air 122 are injected into the diluted used seawater 103B. Such fine air bubbles are generated in all the aeration nozzles 123 to which air is supplied through branch pipes L_{5A} to L_{5H} and the headers 15 (see FIGS. 6 and 7).

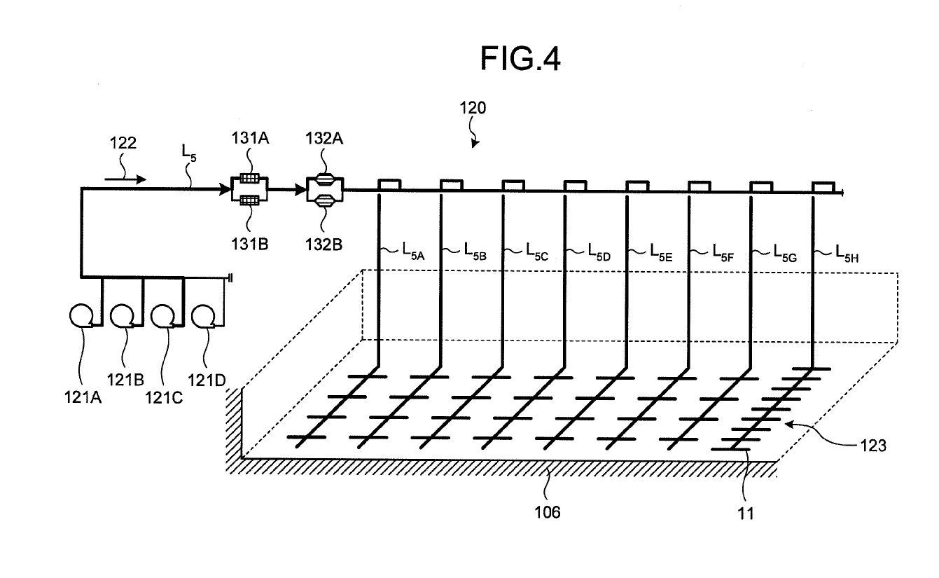

FIG. 4 is a schematic diagram of the aeration apparatus according to the present embodiment. As shown in FIG. 4, an aeration apparatus 120 according to the present embodiment is immersed in diluted used seawater (not shown), which is water to be treated, and generates fine air bubbles in the diluted used seawater. This aeration apparatus 120 includes: an air supply line L₅ that supplies the air 122 from blowers 121A to 121D serving as discharge units; and aeration nozzles 123 each including the diffuser membrane 11 having slits for supplying air.

Two cooling units 131A and 131B and two filters 132A and 132B are respectively provided in the air supply line L₅. Accordingly, air compressed by the blowers 121A to 121D is cooled and then filtered. The cooled and filtered air is supplied by all the aeration nozzles 123 that receive air supply through branch pipes L_{5A} to L_{5H} and the headers 15, thereby generating fine air bubbles.

There are four blowers, but normally, three blowers are used for operation, and one of them is a reserve blower. Since the aeration apparatus must be continuously operated, only one of the two cooling units 131A and 131B and only one of the two filters 132A and 132B are normally used, and the others are used for maintenance.

The aeration apparatus according to the present embodiment is explained below. In the present invention, water-repellent treatment is applied to at least one of the opening and the vicinity thereof of the slit to be formed in the diffuser membrane 11 to prevent the inflow of seawater into the slit, and precipitation of calcium sulfate and the like in the slits 12 can be suppressed and avoided.

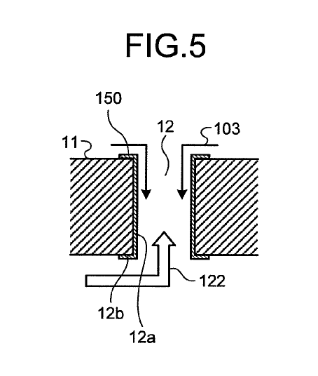

FIG. 5 is a schematic diagram of an opening of the slit 12 formed in the diffuser membrane 11 of the aeration nozzle 123 according to the present embodiment.

As shown in FIG. 5, the slit 12 according to the present embodiment is provided with a water-repellent layer 150 formed on a slit wall surfaces 12a and an edge 12b of the opening. In this manner, by applying the water-repellent treatment to the opening and the vicinity thereof, precipitation of precipitates can be suppressed and avoided.

The salt concentration in seawater is 3.4%, and 3.4% of salts are dissolved in 96.6% of water. The salt includes 77.9% of sodium chloride, 9.6% of magnesium chloride, 6.1% of magnesium sulfate, 4.0% of calcium sulfate, 2.1% of potassium chloride, and 0.2% of other salts.

Of these salts, calcium sulfate is deposited first as seawater is concentrated (dried), and the precipitation threshold value of the salt concentration in seawater is about 14%.

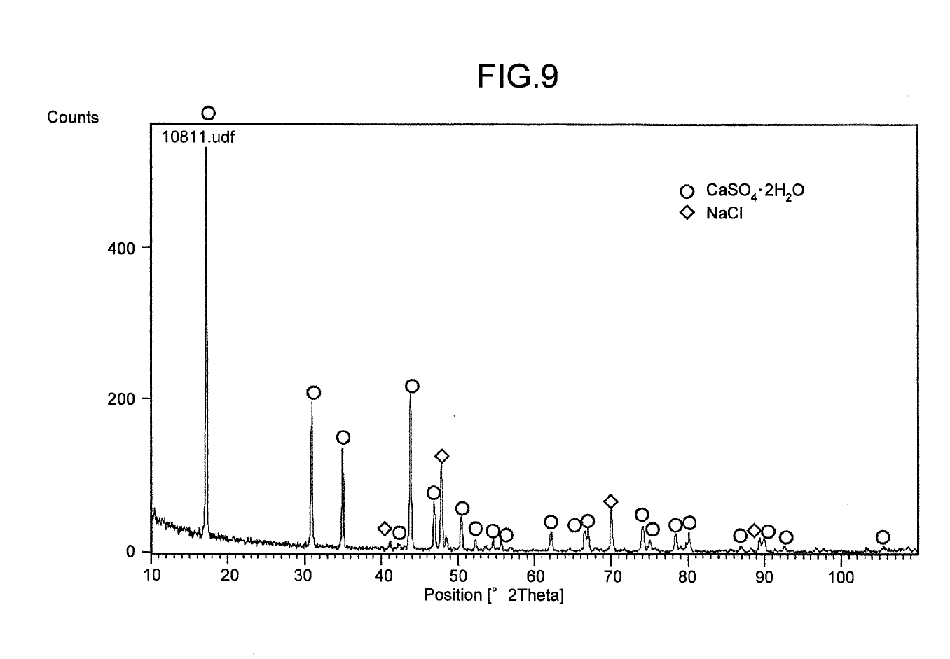

A result of analysis of precipitates adhered to a slit is shown in FIG. 9. FIG. 9 is a chart obtained by analyzing a precipitate by X-ray diffraction. As shown in FIG. 9, it was found that most peaks are derived from calcium sulfate.

A mechanism in which precipitates are deposited in the slits 12 is explained with reference to FIGS. 6A to 6C.

FIG. 6A depicts the outflow of air (humid air having a low degree of saturation), the inflow of seawater, and a state of concentrated seawater in the slit of the diffuser membrane. FIG. 6B depicts the outflow of air, the inflow of seawater, and states of concentrated seawater and precipitates in the slit of the diffuser membrane. FIG. 6C depicts the outflow of air, the inflow of seawater, and states of concentrated seawater and precipitates (when precipitates grow) in the slit of the diffuser membrane.

In the present invention, the slits 12 are cuts formed in the diffuser membrane 11, and the gap of each slit 12 serves as a discharge passage of air.

The seawater 103 is in contact with slit wall surfaces 12a that form the passage. The introduction of the air 122 causes the seawater 103 to be dried and concentrated to form concentrated seawater 103a. A precipitate 103b is then deposited on the slit wall surfaces 12a and clogs the passage in the slits 12.

FIG. 6A depicts a state in which salt content in seawater is gradually concentrated to form the concentrated seawater 103a due to low relative humidity of the air 122 (low degree of saturation). However, even if the concentration of the seawater is initiated, deposition of calcium sulfate and the like does not occur when the salt concentration in the seawater is about 14% or less.

In the state shown in FIG. 6B, the precipitate 103b is generated in portions of the concentrated seawater 103a in which the salt concentration in the seawater locally exceeds 14%. In this state, the amount of the precipitate 103b is very small. Therefore, although the pressure loss when the air 122 passes through the slits 12 increases slightly, the air 122 can pass through the slits 12.

On the other hand, in the state shown in FIG. 6C, because the concentration of the concentrated seawater 103a has proceeded further, a clogged (plugged) state due to the precipitate 103b is formed, and the pressure loss becomes high. Even in this state, the passage of the air 122 remains even in this state; however, a large burden is imposed on a discharge unit.

Therefore, to avoid such a problem, the water-repellent layer 150 is provided at least at one of an opening and the vicinity thereof of the slit 12 to prevent the inflow of seawater into the slit, and suppress and avoid generation of the precipitate 103b in the slit, thereby enabling a stable operation for a long time.

Various water-repellent materials can be mentioned as a material for forming the water-repellent layer. For example, a coating layer formed of a hydrophobic material using talc or silica powder, a fluorine coating layer coated with a fluorine resin, a silicone coating layer coated with a silicone resin, and a wax coating layer coated with wax can be mentioned.

At the time of coating the hydrophobic material, it is desired to use a fixing agent or the like so that the hydrophobic material does not exfoliate immediately. The water-repellent layer can be formed at the time of mold release of the diffuser membrane or thereafter.

As a result of chemically applying the water-repellent treatment by using a water-repellent material in this manner, the surface of the slit has a hydrophobic property to repel water.

Accordingly, the inflow of seawater into the slit can be suppressed and avoided, the salt concentration of seawater is not increased, and precipitation of precipitates is prevented.

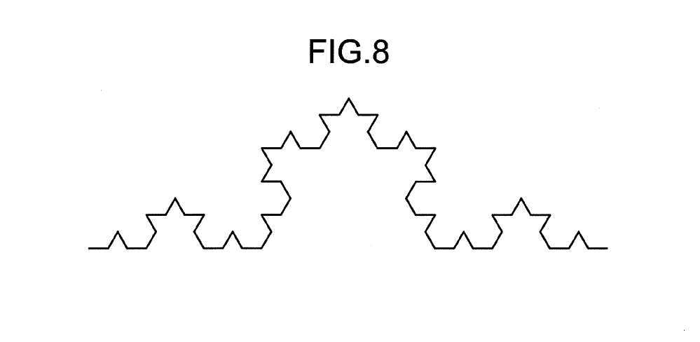

FIG. 8 is a pattern diagram of a fractal structure. The surface of the slit can be formed as a fractal structure layer in which an infinite number of physical concave-convex surfaces are formed, thereby improving its water repellency. The fractal structure has a structure in which concave and convex structures are nested such that small concavity and convexity are present in large small concavity and convexity, such as the Koch curve, and smaller concavity and convexity are present in the small concavity and convexity, thereby increasing its wettability.

At the time of forming the slit, for example, the opening is formed by plasma processing to form an infinite number of concave-convex surfaces in the opening portion. At this time, it is desired that the opening is formed in an inert atmosphere. This is for preventing generation of oxygen functional groups.

While a rubber-made diffuser membrane is desired, the present invention is not limited thereto, and a stainless-steel or resin diffuser membrane can be used, for example.

As a fluorine resin, for example, polytetrafluoro-ethylene (a tetrafluorinated resin, abbreviated as PTFE), polychloro-trifluoroethylene (a trifluorinated resin, abbreviated as PCTFE or CTFE), polyvinylidene fluoride (abbreviated as PVDF), polyvinyl fluoride (abbreviated as PVF), perfluoroalkoxy fluororesin (abbreviated as PFA), tetrafluoroethylene/hexafluoropropylene copolymer (abbreviated as FEP), ethylene/tetrafluoroethylene copolymer (abbreviated as ETFE), ethylene/chlorotrifluoroethylene copolymer (abbreviated as ECTFE) can be exemplified.

This water-repellent treatment is applied after formation of slits.

A hydrophobic material can be added and kneaded to the diffuser membrane 11 itself.

For example, the hydrophobic material can be added in an amount from 25 to 95 parts by weight per 100 parts by weight of a rubber material to form the diffuser membrane. As a result, the diffuser membrane can have a water-repellent layer provided at least at one of an opening and the vicinity thereof of the slit 12. If the added amount of the hydrophobic material is out of the above range, a water-repellent effect cannot be developed, which is not preferable.

For example, the hydrophobic material can include talc and silica power; however, the present invention is not limited thereto.

Further, it is preferable to use ethylene-propylene-diene monomer rubber (EPDM rubber) as the rubber material.

FIG. 7 is a schematic diagram of another aeration apparatus according to the present embodiment.

As shown in FIG. 7, an aeration apparatus 120A according to the present embodiment further includes a hydrophobic-material supply unit 161 that adds a hydrophobic material 160 in the aeration apparatus 120 shown in FIG. 4, to supply the hydrophobic material 160 into the air supply line L₅ through a hydrophobic material line L₆.

For example, as the hydrophobic material 160 to be added, it is desired that at least one of talc and silica powder is used.

As the supply of the hydrophobic material 160, at the time of supplying the air 122 to supply fine air from the aeration nozzles 123, it is desired to remove the precipitate from the slit 12 after pressure fluctuation, and then to apply water-repellent treatment.

As the removal of precipitates, an air purge operation or an air suspending operation is performed so as to give fluctuation to the slit 12 of the diffuser membrane 11, thereby removing the precipitates adhered to the slit 12.

By applying the water-repellent treatment, the slit 12 has water repellency and becomes stain-resistant.

In the present embodiment, while seawater has been exemplified as the water to be treated, the present invention is not limited thereto. For example, plugging caused by deposition of contamination components such as sludge on diffuser slits (membrane slits) can be prevented in the aeration apparatus for aeration of contaminated water in decontamination processing, and thus the aeration apparatus can be stably operated for a long time.

In the present embodiment, while tube-type aeration nozzles have been exemplified for explaining the aeration apparatus, the present invention is not limited thereto. For example, the invention is applicable to disk-type and flat-type aeration apparatuses and to diffusers made of ceramic or metal (ex. stainless).

### INDUSTRIAL APPLICABILITY

As described above, in the aeration apparatus according to the present invention, generation of precipitates can be suppressed and avoided in the slits of the diffuser membranes of the aeration apparatus. For example, when applied to a seawater flue gas desulphurization apparatus, the aeration apparatus can be continuously operated in a stable manner for a long time.

### REFERENCE SIGNS LIST

11 diffuser membrane

12 slit

100 seawater flue gas desulphurization apparatus

102 flue gas desulphurization absorber

103 seawater

103A used seawater

103B diluted used seawater

105 dilution-mixing basin

106 oxidation basin

120, 120A aeration apparatus

123 aeration nozzle

150 water-repellent layer

160 hydrophobic material

1. An aeration apparatus that is immersed in water to be treated and generates fine air bubbles in the water to be treated, the aeration apparatus comprising:
an air supply pipe for supplying air through a discharge unit; and
an aeration nozzle including a diffuser membrane having a slit, the air being supplied through the slit to the aeration nozzle, wherein
a water-repellent layer is provided at least at one of an opening and vicinity thereof of the slit.

2. The aeration apparatus according to claim 1, wherein the water-repellent layer is a coating layer made of a hydrophobic material.

3. The aeration apparatus according to claim 1, wherein the water-repellent layer is any one of a fluorine coating layer, a silicone coating layer, and a wax coating layer.

4. The aeration apparatus according to claim 1, wherein the water-repellent layer is a fractal structure layer.

5. The aeration apparatus according to claim 1, wherein the diffuser membrane is made of rubber, metal, or ceramic.

6. An aeration apparatus that is immersed in water to be treated and generates fine air bubbles in the water to be treated, the aeration apparatus comprising:
an air supply pipe for supplying air through a discharge unit; and
an aeration nozzle including a diffuser membrane having a slit, the air being supplied through the slit to the aeration nozzle, wherein
the diffuser membrane is formed by adding a hydrophobic material thereto in an amount from 25 to 95 parts by weight per 100 parts by weight of a rubber material, and a water-repellent layer is provided at least at one of an opening and vicinity thereof of the slit.

7. An aeration apparatus that is immersed in water to be treated and generates fine air bubbles in the water to be treated, the aeration apparatus comprising:
an air supply pipe for supplying air through a discharge unit;
an aeration nozzle including a diffuser membrane having a slit, the air being supplied through the slit to the aeration nozzle; and
a hydrophobic-material supply unit that adds a hydrophobic material to the air supply pipe.

8. A seawater flue gas desulphurization apparatus comprising:
a desulfurizer that uses seawater as an absorbent;
a water passage for discharging used seawater discharged from the desulfurizer; and
the aeration apparatus according to claim 1 that is disposed in the water passage, the aeration apparatus generating fine air bubbles in the used seawater to decarbonate the used seawater.
